(19) United States
(12) Patent Application Publication
(10) Pub. No.: US 2004/0028510 A1
(43) Pub. Date: Feb. 12, 2004

(54) Mechanically assisted vehicular roof rack

(76) Inventor: Bryon C. Jones, Hurricane, UT (US)

Correspondence Address: TRASK BRITT, P.O. BOX 2550, SALT LAKE CITY, UT, 84110, US

(21) Appl. No.: 10/383,002

(22) Filed: Mar. 6, 2003

Related U.S. Application Data
(60) Provisional application No. 60/362,153, filed on Mar. 6, 2002.

(51) Int. Cl. B60P 9/00

(52) U.S. Cl. 414/462

(57) ABSTRACT

A vehicular rack system for facilitating the loading of rack for carrying equipment that includes a mechanical movement mechanism attached to extendable rack members that may be loaded on the side or rear of a vehicle whereby the mechanical movement mechanism facilitates the movement of the rack members and any equipment attached thereto into a traveling position.

### CROSS REFERENCE TO RELATED APPLICATIONS

This application claims the benefit of United States Provisional Patent Application Serial No. 60/362,153, filed Mar. 6, 2002, for MECHANICALLY ASSISTED VEHICULAR ROOF

### BACKGROUND OF THE INVENTION

1. Field of the Invention

The present invention relates to vehicular racks. More particularly, the present invention relates to a mechanically assisted vehicular roof rack, or roof rack attachment, for assisting with the attachment of devices or equipment to a roof rack, or other vehicular rack, and the placement of those devices or equipment on a vehicle.

2. Background of the Invention

Vehicular roof racks are used for carrying any number of items, most notably, recreational equipment. Accessories, attachments, and other devices may be obtained to attach most anything to a vehicular roof rack. For instance, ski rack attachments, bicycle attachments, canoe attachments, kayak attachments and storage box attachments are a few of the most popular accessories used to secure recreational equipment to a rack on the roof of a vehicle.

Roof rack attachments generally secure to a rail, or bar, that comprises a portion of a vehicular rack. The attachments are usually secured to a rack using fastening devices such as clamps, bolts, screws, or the like. Once secured to the rack, the attachments are used to removably attach recreational equipment, or other items, to the rack. For instance, a set of bicycle attachments for attaching a bicycle to a rack may consist of three attachment pieces. A first attachment piece may include a bicycle fork mount for accepting a bicycle fork and a built-in quick-release mechanism for securing a bicycle fork placed within the fork mount. A second attachment may include a tire mount for accepting and supporting a portion of a rear wheel of a bicycle with the tire placed in the mount and a strap or other securing device for securing a wheel in the tire mount. A third attachment may consist of a wheel mount for holding a bicycle wheel by a quick release mechanism associated with the hub of a bicycle wheel. Bicycle attachment sets similar to the one described may be purchased from many different commercial rack manufactures.

A bicycle may be mounted on a set of bicycle attachments similar to those described. To mount the bicycle on a roof rack, with the set of attachments, a person must be able to access the roof of the vehicle with the bicycle or bicycle parts. For instance, to mount a bicycle to the described set of attachments, the front wheel of the bicycle is first removed from the bicycle fork. Typically, a quick-release device allows easy removal of the front wheel. The front wheel is then positioned in the wheel mount attachment and secured in place by the same quick-release device used to secure the wheel to the bicycle fork. Next, the bicycle must be lifted onto the roof of the vehicle for attachment. The fork of the bicycle is placed in the fork mount and a tire portion of the rear wheel is positioned to rest in the tire mount. The bicycle fork is secured in place using the quick-release mechanism built into the fork mount. The rear wheel of the bicycle is secured to the tire mount using the securing device provided therewith.

In some instances, accessing a roof rack of a vehicle is very difficult. Larger vehicles, such as Sport Utility Vehicles (SUV), trucks, vans, and the like, may require the use of a ladder or other elevating device to reach the roof rack. It is also very difficult to reach the center portions of a roof rack on such vehicles because of the height of the vehicle. In many instances, the use of a roof rack with such vehicles requires the use of a ladder, or other elevating device, to provide access to the roof of the vehicle. Positioning equipment to be attached to a roof rack of such a vehicle becomes very difficult and dangerous because the equipment must be hoisted into place or carried up a ladder.

To ease the difficulties associated with affixing equipment to roof racks, a number of alternative racks or rack attachments have been developed. For example, a loading mechanism for facilitating the loading of equipment onto a roof rack is disclosed in U.S. Pat. No. 5,782,391. The disclosed loading mechanism allows a lift member, or rack bar, to be tilted down the side of a vehicle to facilitate the loading equipment onto the rack. Once loaded, the lift member, and any attached equipment, is manually lifted back onto the vehicle's roof and secured in place.

A similar roof rack system is illustrated in U.S. Pat. No. 5,417,358. The disclosed roof rack system splits the roof rack into two separate halves, each half being extendable away from the center of the vehicle and tiltable down the sides of the vehicle. To load equipment onto the roof rack, one half is extended and tilted to rest against the side of the vehicle. Equipment is then attached to the roof rack while in the tilted position. Once the desired equipment is secured to the rack, the rack may be manually moved back into a horizontal position with the ground and slid back into place on the roof of the vehicle.

An alternative, but similar, approach is disclosed in U.S. Pat. No. 5,360,151. A roof top carrier for bicycles is disclosed, comprising a base that is fastened to the roof of a vehicle and a rack that pivots about the base from a rooftop carrying position to a vehicle side loading position. To load a bicycle onto the disclosed rack, bicycle handles are attached to the rack in the loading position such that the bicycle hangs in an upright position with respect to the ground. The rack and the attached bicycle are pivoted upwards so that the bicycle is secured in an inverted position on the top of the vehicle. Manual force must be used to load a bicycle onto the roof of the vehicle using this invention.

The roof rack improvements do make it somewhat easier to load a roof rack with equipment. However, all of the available roof racks require manual force to lift the rack onto the top of a vehicle once it is loaded. Depending upon the amount of equipment attached to the rack, and the angle at which the rack must be manipulated to reposition it on the roof of a vehicle, the task of moving the rack back onto a vehicle roof may be difficult.

It is therefore desirable to provide an improved rack system for transporting equipment on the tops of vehicles. It is also desirable for a rack system to include a method for assisting with the placement of a loaded rack on the roof of a vehicle.

### SUMMARY OF THE INVENTION

The present invention relates to vehicular racks. More particularly, the present invention relates to a mechanically assisted vehicular roof rack, or roof rack attachment, for assisting with the attachment of devices or equipment to a roof rack, or other vehicular rack, and the placement of those devices or equipment on a vehicle.

The present invention discloses a rack system for use with vehicles. The rack system maybe incorporated with an existing vehicle rack, maybe used in place of an existing vehicle rack, or may be mounted to a vehicle having no rack. One or more rack rails may be provided for supporting attachments and securing equipment to the rack system for transportation or storage. Each rack rail may be moved from a position above a vehicle roof to a position on a side, or rear, of the vehicle for equipment loading. Movement of the rack rails may be manual or mechanically assisted. A rack rail movement mechanism is provided for facilitating movement of a rack rail for use with the rack system.

In one embodiment of the present invention, a rack system is mounted to a vehicle having no preexisting rack. The rack system consists of rack rail guides mounted to the roof of the vehicle with one or more rack rails moveably mounted to the rack rail guides. A rack rail movement mechanism may also be mounted to the roof of the vehicle. The rack rail movement mechanism may be mounted to one or more rack rail guides or may be separately mounted to the vehicle roof. The rack rail movement mechanism may also include an on/off switch, remote control, or other mechanism, for operating the rack rail movement mechanism. One or more rack rails maybe connected to the rack rail movement mechanism such as by rope, wire, webbing, or other connection device.

To load equipment onto the rack system, one or more rack rails may be extended outward and downward from the roof of the vehicle into a loading position. Typically, a user must extend the rack rails to the side or rear of the vehicle. A loading position may include positioning of the rack rails next to the side of a vehicle or parallel to the ground next to a vehicle. Rack rail guides support and direct the movement of the rack rails when they are being pulled off of the top of the vehicle. Pulling the rack rails outward and downward, the rack rail movement mechanism allows the connection device attaching the rack rail movement mechanism to the rack rails to move with the rack rails. For instance, if the rack system includes a single rack rail attached to the movement mechanism by a webbing belt, the movement mechanism feeds or releases portions of the webbing belt as the rack rail is pulled by a person outward and downward from the vehicle. As the rack rail is moved from the top of the vehicle, where it is parallel to the ground surface, the rack rail may bend from the roof of the vehicle towards the ground. Preferably, the rack rail is pulled from the roof of the vehicle at about a thirty-degree angle. A stopper in combination with a rack rail guide, or the connection device, may prevent the rack rail from being pulled completely off of the roof of the vehicle. For example, the webbing belt may be limited to a certain length, such that when the entire webbing belt has been released from the movement mechanism, the rack rail is prevented from further movement. In this manner, a portion of the rack rail remains on the vehicle roof.

Attachments for holding and securing equipment maybe attached to the rack rail in the loading position or when the rack rail is positioned on top of the vehicle. Equipment, such as bicycles, canoes, skies, cargo carriers, or the like, may be attached to the rack rail attachments when the rack rail is in the loading position. Once loaded, the rack rail may be moved back into a position on the roof of the vehicle. To move a loaded rack rail back into position on the roof of a vehicle, the movement mechanism may be engaged to assist in retracting the rack rail, and attached equipment, back to the top of the vehicle. Once engaged, the movement mechanism retracts the connection device attached to the rack rail. The connection device in turn pulls the rack rail and any attached equipment back onto the roof of the vehicle. For example, the webbing belt previously described may be used to retract a rack rail back from the loading position to a position on the roof of the vehicle.

In another embodiment of the present invention, more than one rack rail may be incorporate into the rack system. In addition, the rack rails may be extendable off of the back of the vehicle rather than off the side of the vehicle.

In an alternate embodiment of the present invention, one or more legs may be attached to a rack rail in a loading position. A rack rail leg may extend from one end of the rack rail to the ground to offer support during the loading of the rack rail. Alternatively, the rack rail leg may be incorporated with the rack rail such that when the rack rail is fully extended into the loading position, the rack rail leg may be extended to the group to support the loading of the rack rail.

In another embodiment of the present invention, a vehicle support may also be incorporated with the rack rails to provide a support member for the rack rail. The vehicle support may extend from a rack rail in a loading position back to the vehicle to provide support during the loading of the rack rail. The vehicle support may be incorporated with a rack rail or may be a separate piece of equipment that may be fixed to the rack rail during loading.

In yet another embodiment of the present invention, the rack system may be incorporate with a preexisting vehicle roof rack. The rails of the preexisting vehicle roof rack may be used as rack rail guides for the rack rails of the rack system. The rack rails may ride on top of the preexisting roof rack rails with the aid of brackets or other movement devices. Alternatively, the rack rails may be connected to wheels that ride under the preexisting roof rack rails, thereby guiding the movement of the rack rails along the path of the preexisting roof rack rails.

In another embodiment of the present invention, the rack rails maybe telescoping rack rails such that the rack rails may be retracted into a smaller unit and extended into a larger unit.

In yet another embodiment of the present invention, the rack system maybe attached to a trunk of a vehicle for supporting and transporting equipment on the trunk of the vehicle. For instance, a rack system of the present invention may be attached to the trunk of a vehicle for facilitating the transport of sports equipment, wheelchairs, or other devices.

### DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1 illustrates a rack system of the present invention in a traveling position;

FIG. 2 illustrates the rack system of FIG. 1 in an intermediary position;

FIG. 3 illustrates one embodiment of the movement mechanism of the present

FIG. 4 illustrates a bracket used with the present invention;

FIG. 5 illustrates a roof rail and rack member connection according to the present

FIG. 6 illustrates a rear view of the rack system of the present invention in a loading

FIG. 7 illustrates one embodiment of a leg support of the present invention;

FIG. 8 illustrates an alternate embodiment of a leg support of the present invention;

FIG. 9 illustrates an alternate embodiment of a leg support of the present invention;

FIG. 10 illustrates a single rack member embodiment of the present invention;

FIG. 11 illustrates a telescoping rack system according to the present invention; and

FIG. 12 illustrates an alternate embodiment of a rack system of the present invention operating on the trunk of a vehicle.

### DETAILED DESCRIPTION OF THE INVENTION

The present invention relates to vehicular racks. More particularly, the present invention relates to a mechanically assisted vehicular roof rack, or roof rack attachment, for assisting with the attachment of devices or equipment to a roof rack, or other vehicular rack, and the placement of those devices or equipment on a vehicle.

The various embodiments of the present invention disclose a movable rack system for carrying equipment or other items on a vehicle. Using the rack system, one or more rack members may be moved from the top of a vehicle to the side or rear of the vehicle for loading. A mechanism for facilitating the movement of rack members may be used to reposition rack members from the loading position to a transportation position atop a vehicle: In this manner, the loading and unloading of equipment or other items from vehicle racks may be mechanically assisted, thereby simplifying the loading of a vehicular rack.

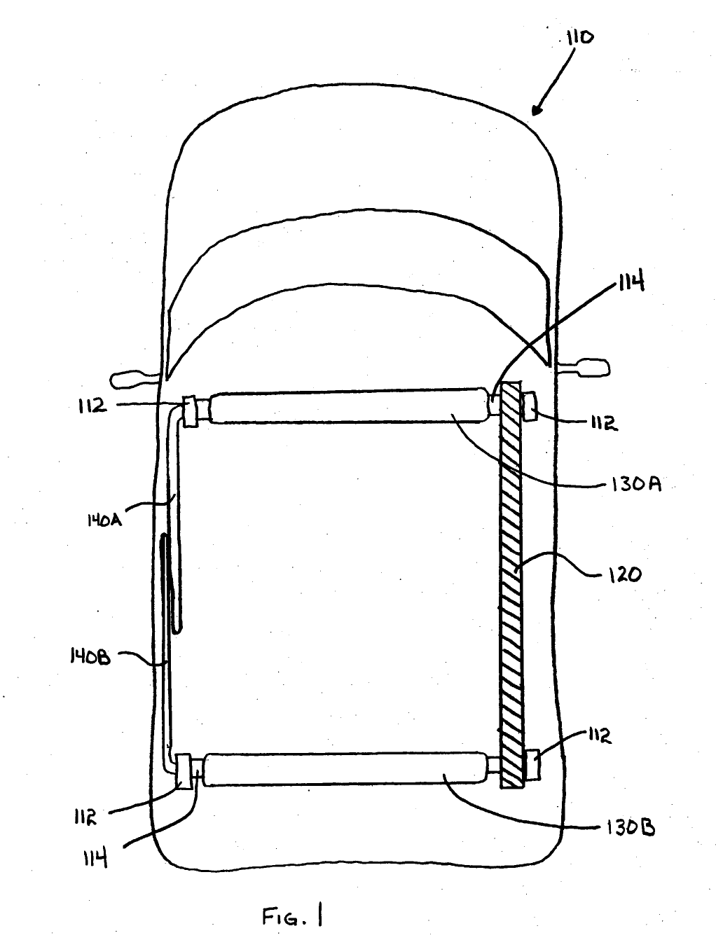

A top view of one embodiment of the present invention is illustrated in FIG. 1. The rack system of the present invention may be fixed to a vehicle 110 having a preexisting roof rack consisting of rail mounts 112 and roof rails 114. The rack system comprises a movement mechanism 120, one or more rack members 130 and one or more rack member guides 140. Rack member guides 140 may be mounted to rail mounts 112 or to roof rails 114 to provide an extension to a roof rail 114 along which rack members 130 may move. In addition, rack member guides 140 may be pivoted, or otherwise moved, from a position substantially parallel to movement mechanism 120 to a position that is substantially perpendicular to movement mechanism 120. The rack system illustrated in FIG. 1 includes two rack members 130A and 130B, and two rack member guides 140A and 140B. As illustrated, the rack member guides 140 are positioned in a substantially parallel position with respect to the movement mechanism 120.

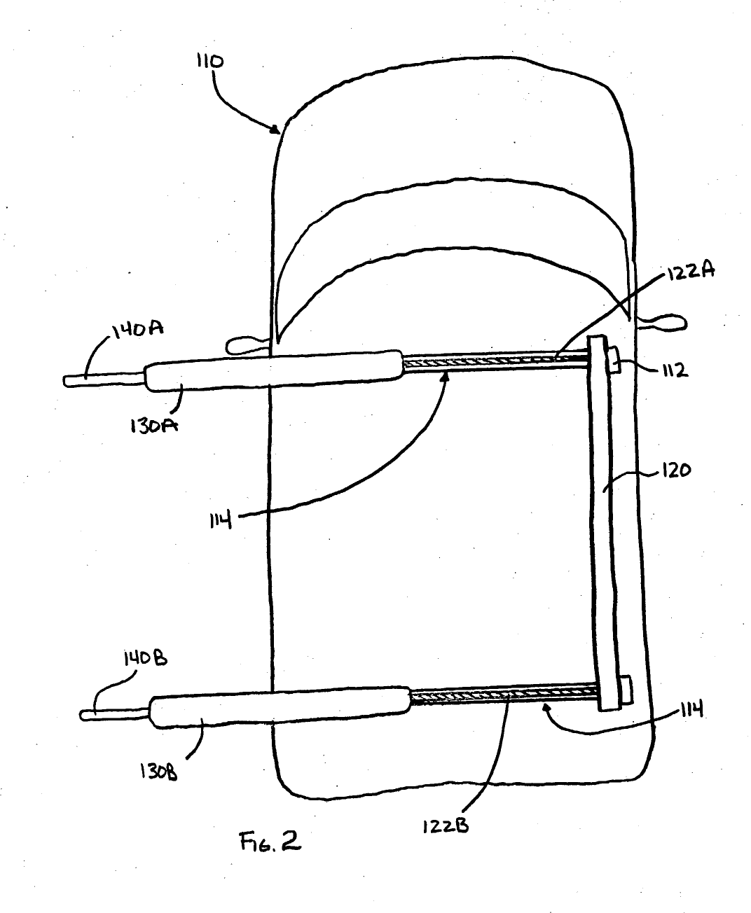

FIG. 2 illustrates a top-down view of the same rack member guides 140A and 140B pivoted into a position that is substantially perpendicular to the movement mechanism 120. In the extended position, or loading position, rack members 130A and 130B maybe moved along a roof rail 114 and onto the respective rack member guide 140A or 140B. As illustrated, rack member 130A is positioned on both roof rail 114 and a portion of rack member guide 140A. Rack member 130B mirrors the positioning of rack member 130A along rack member guide 140B. Although rack members 130A and 130B are illustrated in relatively similar positions along the respective rack member guides 140, rack members 130 may be moved independently along roof rails 114 and rack member guides 140 such that the position of rack member 130A would not mirror that of rack member 130B.

Movement attachments 122A and 122B may be attached to rack members 130A and 130B, respectively. A movement attachment 122 may also be connected to movement mechanism 120 whereby movement mechanism may exert a force on movement attachments 122 to move rack members 130. For instance, a piece of nylon webbing may be used as movement attachment 122. The movement attachments 122 may be attached to a rack member 130 by bolt, screw, clip, clamp, or other fastening device. The movement attachments 122 may also be attached to movement mechanism 120 in a similar manner. Portions of movement attachments 122 may be wound around portions of movement device 120 such that as rack member 130 is moved away from movement mechanism 120, the webbing, or other movement attachment 122, maybe gradually unwound from movement device 120. To retract extended rack members 130 into a position atop roof rails 114, movement mechanism 120 may rewind or otherwise retract the movement attachment 122. Other materials may also be used as movement attachments 122, including rope, wire, bungee cord, shock cord, chains, belts, and the like.

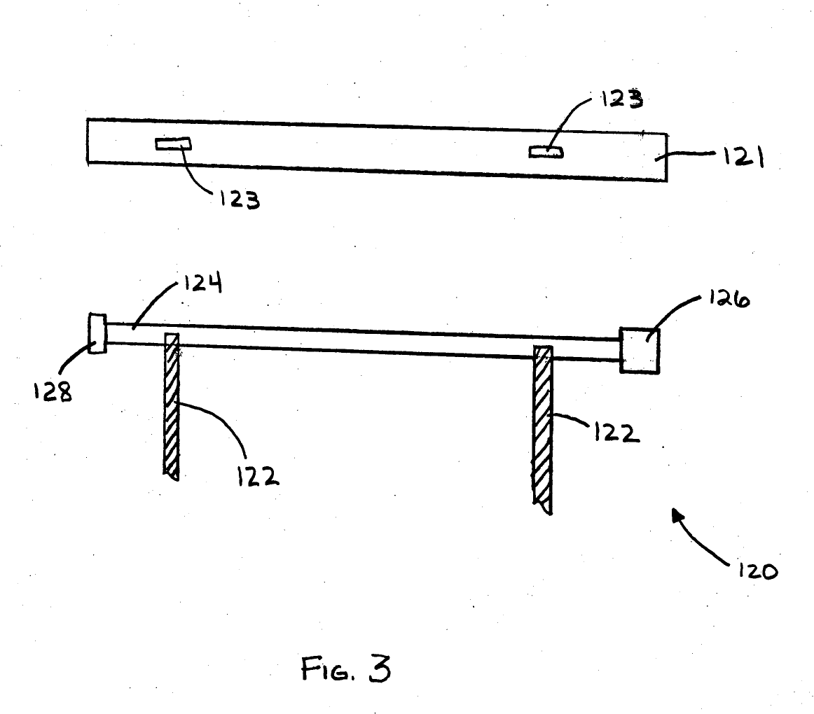

Movement mechanism 120 may include any of a number of different mechanisms for retracting a movement attachment 122 and thereby moving a rack member 130 along a rack rail 114 or rack member guide. One example of a movement mechanism 120 is illustrated in FIG. 3. Movement mechanism 120 may include a rotating bar 124 mounted between a motor 126 and a bar mount 128. The rotating bar 124 is preferably connected to motor 126 such that motor 126, when activated, may rotate the rotating bar 124. Bar mount 128 supports rotating bar 124, allowing the rotating bar 124 to rotate. Movement attachments 122, such as webbing, may be fixed, or secured, to rotating bar 124 such that as motor 126 rotates rotating bar 124, the movement attachments 122 are wound about the rotating bar 124. A cover 121 for the movement mechanism 120 may be fitted over the rotating bar 124, motor 126, and bar mount 128 to protect the movement mechanism 120. Cover 121 may also include guide holes 123 or openings through which movement attachments 122 may pass to allow attachment of the movement attachments to rack members 130.

The movement mechanism 120 may allow a rack member 130 to be moved along a rack rail 114 by rotating as a rack member 130 is moved away from the movement mechanism 120 along a rack rail 114. As a rack member 130 is moved away from the movement mechanism 120, the movement attachment 122 attached to the rack member 130 may be unwound from the rotating bar 124 of movement mechanism 120. When the movement mechanism 120 is engaged to retract a rack member 130, the motor 126 of movement mechanism 120 rotates the rotating bar 124 and winds the movement attachment 122, thereby moving a rack member 130 to a position on top of a vehicle 110.

Other movement mechanisms 120 may include the use of springs or pulleys for assisting with the movement of rotating bar 124. For example, a spring system similar to those used to assist in the operation and movement of a garage door may be incorporated with the movement mechanism of the present invention.

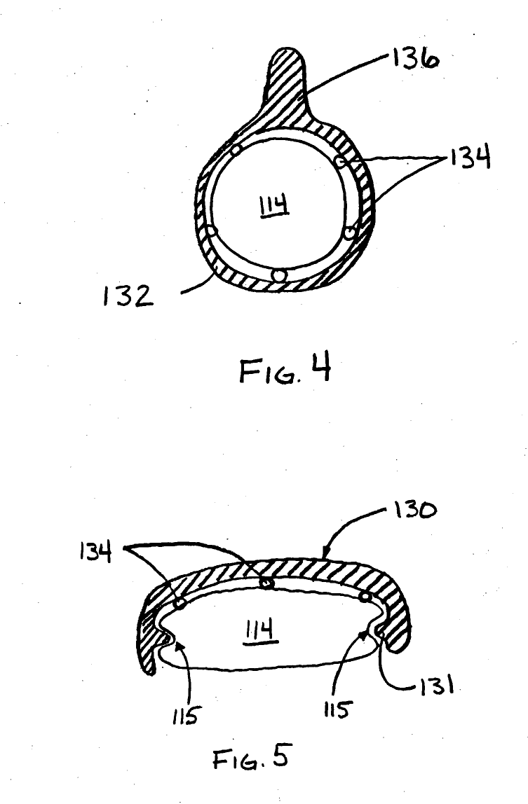

Rack members 130 may be made of many different types of material and may include many different shapes and sizes. For instance, rack members 130 may comprise tubing or other shapes made of plastics, metals, carbon fiber, wood, fiberglass, nylon, or other suitable materials. Each rack member 130 may be moveably attached to the roof rails 114 by any number of devices. For instance, a bracket 132 may be attached to a roof rail 114, wherein the bracket 132 includes a plurality of integrated bearings 134 for facilitating movement of the bracket 132 along a roof rail 114 as illustrated in FIG. 4. Bracket 132 may also include a rack member attachment portion 136 for connecting to a rack member 130 for providing movement to the rack member 130 along the roof rail 114. A bracket 132 connected to a rack member 130 with rack member attachment portion 136 may be movable along a rack rail 114. As a rack member 130 is moved with respect to a rack rail 114, the bracket slides with the rack member 130 along the rack rail.

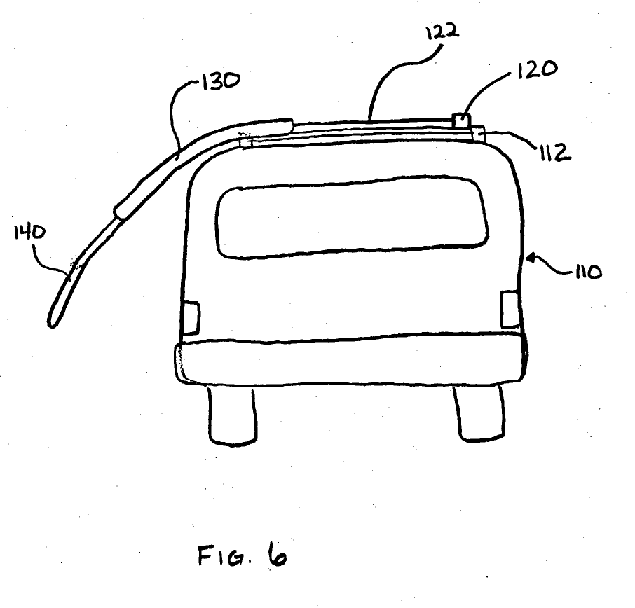

In an alternate embodiment, a rack rail 114 may include grooves 115 for accepting groove fittings 131 of a rack member 130 as illustrated in FIG. 5. The groove fittings 131 of a rack member 130 may fit within the grooves 115 of the rack rail 114 such that the rack member 130 may be moveably secured to the rack rail 114. The rack member 130 may slide along the rack rail 114 guided by the groove fittings 131 fitted in grooves 115. Optional bearings 134 maybe included with rack member 130 for facilitating movement of the rack member 130 along rack rail 114. Bearings 134 may be integrated with a rack member 130 as desired to facilitate movement along a rack rail 114.

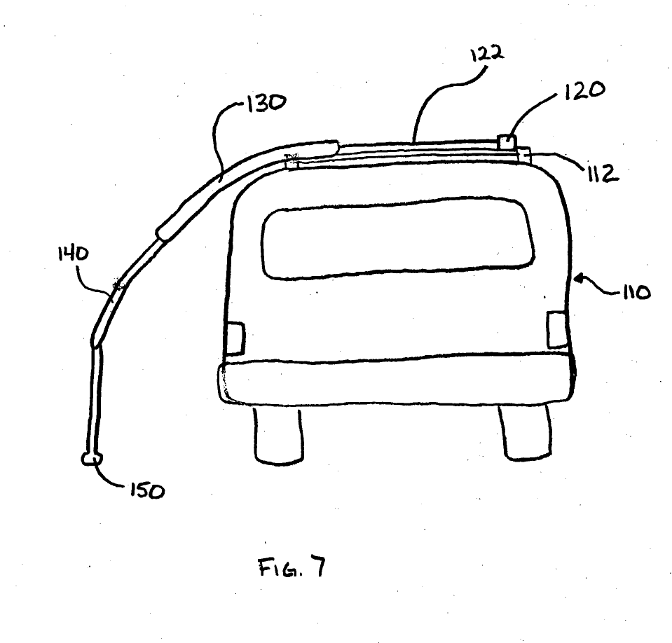

A rear view of the rack system illustrated in FIG. 2 is illustrated in FIG. 6. As shown, the rack member guides 140 may not be ridged. Rather, the rack member guides 140 may be flexible and in an extended position, or loading position, the rack member guides 140 may angle downwards from the roof of the vehicle. Rack members 130 may travel along the rack member guides 140 following the curvature of the rack member guides 140. Thus, rack members 130 may also be flexible or bendable in order to facilitate movement along a rack member guide 140.

Rack attachments (not shown) for attaching equipment or other items to a vehicle roof rack maybe fixed or moveably attached to rack members 130 for holding or securing equipment to the rack system of the present invention. The use of rack attachments with traditional vehicular roof racks is well known. Rack attachments may be attached to the rack members 130 of the present invention in the same manner as they are fastened to such traditional roof racks. Unlike traditional roof racks, however, the rack attachments may be lowered to the side or rear of a vehicle because they are attached to the moveable rack members 130. The ability to move the rack members 130 to the side or rear of a vehicle facilitates easier loading of equipment onto the rack attachments.

The embodiment of the present invention illustrated in FIGS. 1 through 6 may facilitate the loading of equipment, or other items, onto a vehicular roof rack. The present invention is easily used to facilitate such loading. A rack system in a traveling position is illustrated in FIG. 1. To adjust the rack system into a loading position, as illustrated in FIGS. 2 and 6, a user may extend or move the rack member guides 140 from a position substantially parallel to the movement mechanism 120 into a position that is substantially perpendicular to the movement mechanism 120. When the rack member guides 140 are extended into a loading position, the rack members 130 may be moved, or pulled, off of the roof rail 114 and onto the rack member guide 140. As a rack member 130 is moved onto a rack member guide 140, a movement attachment 122 attached to the rack member 130 may be unwound from the movement mechanism 120. Once the movement attachment 122 is fully unwound from the movement mechanism 120, the rack member 130 may not be extended further. A rack member 130 in such a position is ready for loading.

The loading of equipment onto one or more rack members requires a user to lift the item being loaded to a rack attachment of a rack member 130 while the rack member 130 is along side of the side or rear of a vehicle. The position of the rack member 130, and rack attachments connected thereto, facilitates the loading of an item onto the rack member 130 because the item only has to be lifted or maneuvered to the rack member 130 location rather than to the top of the vehicle. Thus, the amount of force or strength required to load an item onto the rack member is less than that required to load the same item onto the roof or other portion of the vehicle.

Once one or more rack members 130 are loaded, the movement mechanism 120 may be engaged to facilitate the movement of the rack members 13.0 and any loaded items back to a position on top of the vehicle 110. When engaged, the motor 126 of the movement mechanism 120 engages the rotating bar 124, causing the rotating bar 124 to begin to wind the movement attachments 122 onto the rotating bar 124. As the movement attachments 122 are wound onto the rotating bar 124, the rack members 130 are pulled from the rack member guides 140 onto the roof rails 114. When the movement mechanism 120 has completed moving the rack members 130 into a position on the roof rails 114 for traveling, the movement mechanism ceases operation. The rack member guides 140 may then be rotated or moved back into position as shown in FIG. 1. Thus, the rack system is in a traveling position and acts as a traditional roof rack.

In an alternate embodiment of the present invention, certain safety features may be incorporated with the rack system. For instance, when the rack member guides 140 are secured in the traveling position as illustrated in FIG. 1, the rack members 130 may be locked into position on the roof rails 114 such that the rack members 130 are not moveable. Disengaging, or moving, the rack member guides 140 from the traveling position may unlock the rack members 130 from roof rails 114 so that rack members 130 may be moved along the roof rails 114 and rack member guides 140.

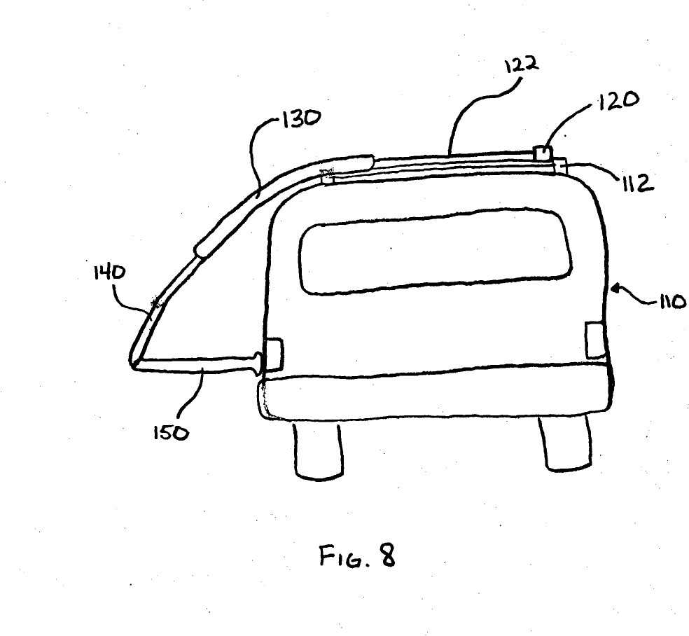

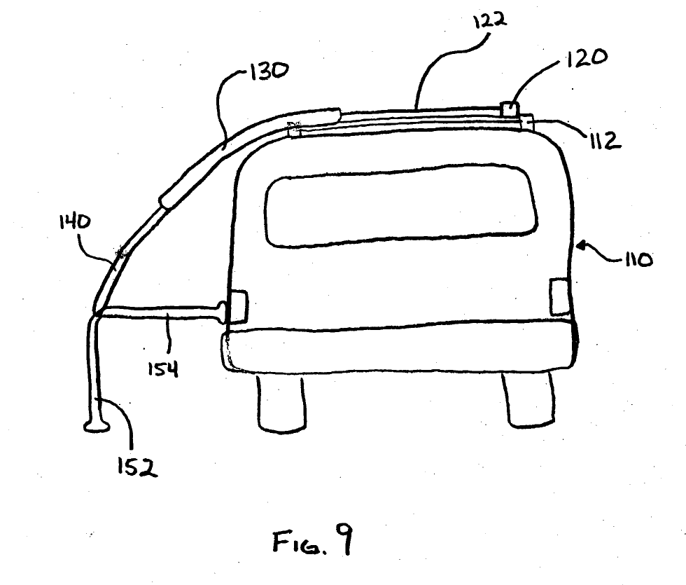

In yet another embodiment of the present invention, support legs 150 may be included to help support the rack member guides 140, and the rack members 130, when in a loading position. As illustrated in FIG. 7, support legs 150 may extend from the end of a rack member guide 140 to the ground. The support legs 150 in such a position provide additional support during the loading of the rack members 130 and allow more weight and pressure to be placed on the rack members 130 and rack member guides 140 in a loading position. Alternatively, support legs 150 may extend from the end of a rack member guide 140 to the vehicle 110 as illustrated in FIG. 8. In still another configuration, support legs 150 may include a first leg portion 152 extending from an end of a rack member guide 140 to the ground and a second leg portion 154 extending from the same end of a rack member guide 140 to the vehicle. A configuration of this sort is illustrated in FIG. 9.

Support legs 150 may be integrated with rack member guides 140 such that when a rack member guide 140 is extended into a loading position a support leg 150 may be folded from the rack member guide 140 into position. For instance, one end of a support leg 150 maybe pivotally attached to an end of the rack member guide 140. The support leg 150 may fold up against the rack member guide 140 for storing during non-loading periods. In a loading position, however, the support leg 150 may be pivoted into position about the pivot attachment with the rack member guide 140.

Support legs 150 may also be detachable or freestanding components that are positioned after the rack member guides 140 are moved into a loading position. Regardless of the type of support leg 150 used, the support legs 150 offer support to the rack member guides 140 and rack members 130 during the loading of the rack members 130.

In another embodiment of the present invention, the rack system maybe attached to a vehicle 110 that is not equipped with a preexisting roof rack. In such instances, the rack system includes roof rails 114 and rail mounts 112 for securing the roof rails 114 to the roof of the vehicle 110. In all other respects, the rack system with roof rails 114 and roof mounts 112 may be used in the same manner as the other embodiments of the present invention.

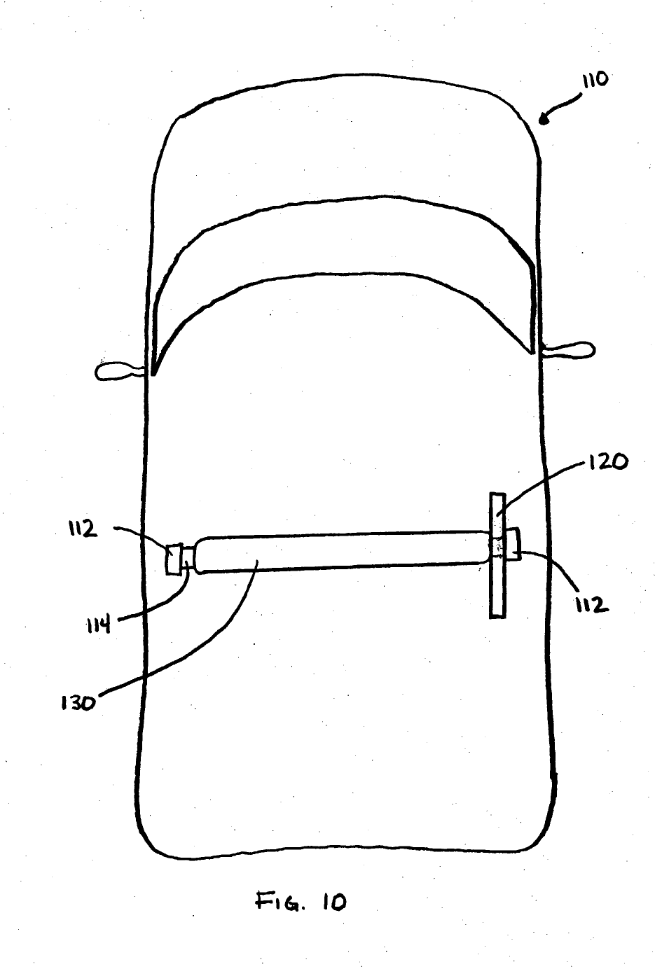

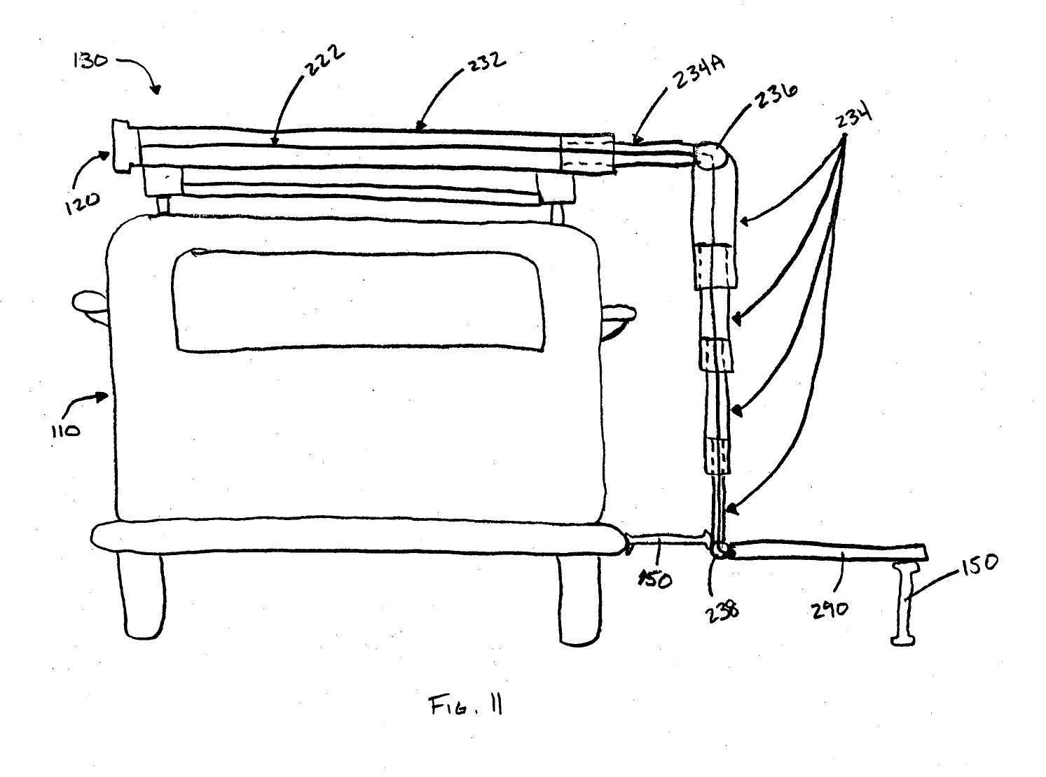

In another embodiment of the present invention, a single rack member 130 may be used instead of two rack members 130. FIG. 10 illustrates an example of a rack system utilizing a single rack member 130. In some instances, a rack system incorporating a single rack member 130 may be better suited for use with vehicles 110 having no preexisting roof rack because a single roof rail 114 and rail mounts 112 may be easily fixed to the roof of the vehicle 110. Use of the single rack member 130 rack system maybe performed in the same manner as the use of the double rack member 130 rack system.

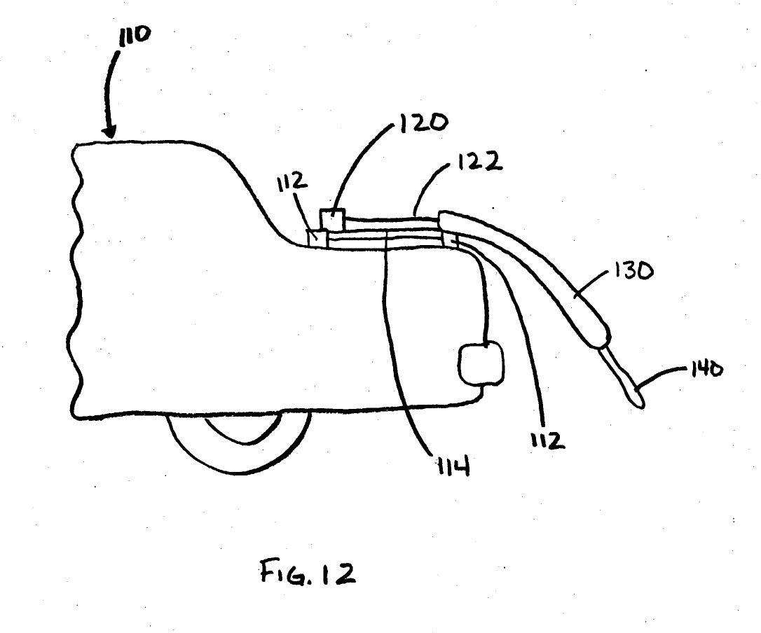

In yet another embodiment of the present invention, the rack members 130 may consist of telescoping members 230 that retract into one another for storing on top of a vehicle and retract out of each other for loading a vehicular rack. For instance, a telescoping rack system according to this embodiment of the present invention is illustrated in FIG. 11. A rack member 230 of the telescoping rack system may include a rack member housing 232 and telescoping rack member positions 234. A rack 290 may be attached to the telescoping rack members 234 by a ball joint 238 or hinge porting equipment to be mounted to the telescoping rack system.

A first telescoping rack member portion 234A may include a ball joint 236 or hinge for allowing the remaining telescoping rack member portions 234 to extend perpendicularly to the ground after the first telescoping rack member portion 234A is extended. Each telescoping rack member portion 234 may also include a keeper plate 238 for preventing a telescoping rack member portion 234 from falling out of another telescoping rack member portion 234. The telescoping rack system may also include a movement mechanism 120 as in the other embodiments of the present invention described herein. A movement attachment 222 may extend from the movement mechanism 120 and attach to a rack 290 that acts as the support for equipment attached to the telescoping rack system. When extended, the telescoping rack members 234 of the telescoping rack system position rack 290 in a substantially parallel position to the ground for loading equipment onto rack 290. Once loaded, rack 290 may be gently lifted, with the aid of movement mechanism 120 and movement attachments 222, so that the telescoping rack member portions 234 retract into each other and into rack member housing 232. This movement may position rack 290 on top of the rack member housing 232 so that the equipment loaded onto rack 290 may be transported on the top of the vehicle.

Support legs 150 may also be incorporated with the telescoping rack system to help support the telescoping rack member portions 234 and the rack 290. Rack members 130 using telescoping rack member portions 234 may also be incorporated with other embodiments of the present invention.

In another embodiment of the present invention, the rack system may be incorporated with a rail system mounted to truck. For instance, pick-up tucks may include two rails mounted along, or above, the longest bed walls of the truck bed. The rack system of the present invention may be mounted to the rails wherein the rails are used in place of the roof rails 114 of the other embodiments of the present invention.

The rack system of the present invention may also be mounted to the trunk of a vehicle 110 for carrying equipment over the trunk of the vehicle as illustrated in FIG. 12. For instance, a rack system may be attached to the trunk portion of a vehicle so that rack members 130 may be maneuvered off the back of the vehicle for loading. The rack members 130 may be loaded with equipment, such as a wheelchair, and moved back to a position above the trunk of the vehicle by the movement mechanism 120.

In another embodiment of the present invention, the rack members may be used to support a tabletop that maybe positioned along side of a vehicle or on top of a vehicle. Alternatively, the rack members 130 may be joined by a solid piece of material that may act as a tabletop such that when the members 130 are extended to the sides or rear of a vehicle, the rack members create a table.

The use of the movement mechanism 120 of the present invention to assist with the movement of loaded rack members 130 back to the roof or trunk of a vehicle 110 makes it easier for an individual to load the rack system with equipment without assistance. Furthermore, an individual lacking the strength to lift equipment to the roof or trunk of a vehicle 110 for loading onto a rack may be able to use the present invention to load a rack system. The loading of equipment onto rack members 130 next to the vehicle requires less strength than lifting the equipment to the roof or trunk of a vehicle 110. In addition, the movement mechanism 120 may be used to pull the loaded rack members 130 onto the vehicle 110, thereby making it easier to load the vehicle.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A method for loading a vehicular roof rack, comprising:
extending at least one rack member of a roof rack from the top of a vehicle to the side of said vehicle;
loading equipment onto said at least one rack member; and
engaging a movement mechanism attached to said at least one rack member to assist in moving said at least one rack member and any attached equipment back to the top of said vehicle.

2. The method of claim 1, further comprising extending at least one rack member guide to the side of said vehicle for supporting said at least one rack member in said extended position.

3. The method of claim 1, wherein engaging said movement mechanism comprises engaging a remote control apparatus.

4. The method of claim 1, wherein engaging said movement mechanism comprises activating a manual switch attached to said roof rack.

5. The method of claim 1, further comprising providing a stopper mechanism and activating said stopper mechanism to prevent said rack member from being pulled off of said vehicle.

6. A vehicular rack system for attachment to a preexisting vehicular roof rack, comprising:
at least one rack member moveably attached to a roof rail of said preexisting vehicular roof rack;
at least one rack member guide attached to said roof rail, said rack member guide extending from said roof rail; and
a movement mechanism attached to said at least one rack member for facilitating movement of said rack member along said roof rail and said at least one rack member guide.

7. The vehicular rack system of claim 6, further comprising:
at least one bracket about said roof rail, said at least one bracket having a rack member attachment portion; and
a fixed connection between said at least one bracket and said at least one rack member whereby said bracket facilitates movement of said rack member on said roof rail.

8. The vehicular rack system of claim 6, wherein said roof rail includes at least one groove for accepting at least one groove fitting of said rack member for facilitating movement of said rack member over said roof rail.

9. The vehicular rack system of claim 6, wherein said movement mechanism comprises:
a motor;
a rotating bar having a first end and a second end, said first end coupled to said motor; and
a bar mount, said second end of said rotating bar supported by said bar mount.

10. The vehicular rack system of claim 9, further comprising at least one movement attachment connected at a first end to said at least one rack member and connected at a second end to said rotating bar.

11. The vehicular rack system of claim 9, further comprising a manual switch attached to said vehicular rack system to activate said movement mechanism.

12. The vehicular rack system of claim 9, further comprising a remote control apparatus adapted to activate said movement mechanism.

13. The vehicular rack system of claim 9, further comprising a stopper mechanism attached to said rail member guide to prevent said rack member from being pulled off of said vehicle.

14. The vehicular rack system of claim 9, further comprising one or more legs attached to said rack member to provide support during loading of said rack member.

15. The vehicular rack system of claim 9, wherein said rack member comprises a material selected from the group consisting of plastics, metals, carbon fiber, wood, fiberglass, and nylon.

16. The vehicular rack system of claim 9, further comprising a vehicle support extending from said rail member to the vehicle to provide support during the loading of the rack member.

17. A method for facilitating the loading of a vehicular rack, comprising:
providing rack rails capable of extending to the side of a vehicle for loading said rack rails; and
providing a movement mechanism for retracting extended rack rails onto a vehicle for transportation.

18. The method of claim 17, wherein said rack rails are moveably attached to a roof rack.

19. The method of claim 17, wherein said rack rails are moveably attached to a trunk rack.
